(19) United States
(12) Patent Application Publication
(10) Pub. No.: US 2010/0191778 A1
(43) Pub. Date: Jul. 29, 2010

(54) METHOD FOR CONSTRUCTING A FILE FORMAT AND APPARATUS FOR PROCESSING A BROADCASTING SIGNAL INCLUDING A FILE HAVING THE FILE FORMAT AND METHOD THEREOF

(76) Inventor: Jeong Woo Kim, Seoul (KR)

Correspondence Address: HARNESS, DICKEY & PIERCE, P.L.C., P.O. BOX 8910, RESTON, VA, 20195, US

(21) Appl. No.: 12/450,008

(22) PCT Filed: Mar. 7, 2008
(86) PCT No.: PCT/KR2008/001319

§ 371 Date: Mar. 15, 2010

(51) Int. Cl. G06F 17/30

(52) U.S. Cl. 707/821; 707/E17.005

(57) ABSTRACT

A method for constructing a file format is provided. The file format includes a first box (mdta) including at least one track with both media data and user data regarding the media data defined in the at least one track and a second box (moov) including a track box (trak) indicating each of the at least one track and a user data box (udta) that defines data and an informative format of a user regarding the user data. The user data box (udta) includes at least one third box (cmdt) including information that can be used to identify a track box indicating a track in which the user data is defined. Multiple users can individually store own unique data in previously created files and it is possible to intuitively determine which track is specified by each user data.

### TECHNICAL FIELD

The present invention relates to a file format structure, and more particularly, to a method for constructing a file format for a file containing user data and an apparatus and method for receiving and processing a broadcast signal including a file having the file format constructed according to the method.

### BACKGROUND ART

Personal Computers (PCs) have been widely spread at home due to the rapid development of the Internet and PC technologies. PCs provide environments in which users can easily access and use a variety of content over the Internet.

Networks, which are typically established around apartment buildings for connection to the Internet through fiber optic cables, provide a high transfer rate of about 100 Mbps. However, such networks are still insufficient to enjoy content with a high resolution or high image quality which requires transmission of a large amount of data.

Recently, broadcast environments are very rapidly changing due to the commercialization of digital broadcasting that is replacing conventional analog broadcasting.

Conventional file formats are also insufficient to fully transmit and receive a desired amount of data in such broadcast environments. That is, there is a need to define or construct new file formats replacing conventional file formats to cope with changes in broadcast environments.

Generally, such new file formats can be defined variously according to the specifications.

File format structures as examples of such various file formats can be generally represented by boxes that are defined according to the specifications.

While users passively consume transmitted content in conventional broadcast environments, recently users have begun to create as well as consume content. An example of such content is User Created Content (UCC) that is prevalent these days.

Thus, file formats defined in conventional broadcast environments are insufficient to define files in such new broadcast environments. Thus, the present invention will suggest defining new file formats, which enable reception and processing of files containing various data created by various creators, and general and generic file formats to cope with future changes in broadcast environments.

### DISCLOSURE OF INVENTION

### Technical Problem

An object of the present invention devised to fulfill the suggestion lies in providing a method for constructing a file format including user data and an apparatus and method for processing a broadcast signal including a file having the file format.

### Technical Solution

An embodiment of the present invention provides a method for constructing a file format, wherein the file format includes a first box including at least one track with both media data and user data regarding the media data defined in the at least one track and a second box including a track box indicating each of the at least one track and a user data box that defines data and an informative format of a user regarding the user data, wherein the user data box includes at least one third box including information that can be used to identify a track box indicating a track with the user data defined in the track.

Here, the third box may further include information regarding a start position of each user data in the track indicated by the track box.

In addition, the third box may further include information that can be used to identify a user who has added user data in the first box.

Moreover, the third box may further include information regarding a version of user data in the first box.

Another embodiment of the invention provides a method for constructing a file format, wherein the file format includes a first box including at least one track with both media data and user data regarding the media data defined in the at least one track and a second box including a track box indicating each of the at least one track and including a user data box that defines data and an informative format of a user regarding the user data, wherein the user data box includes at least one third box including information regarding a start position of the user data in the corresponding track.

Here, the third box may further include information that can be used to identify a user who has added user data in the first box.

In addition, the third box may further include information regarding a version of user data in the first box.

Another embodiment of the invention provides a method for receiving and processing a broadcast signal including files defined according to a specific file format, the method including receiving and storing the broadcast signal; demultiplexing files in the stored broadcast signal, each of the demultiplexed files including a first box including at least one track with both media data and user data regarding the media data defined in the at least one track and a second box including a track box indicating each of the at least one track and a user data box that defines data and an informative format of a user regarding the user data; reading a user data box in each of the demultiplexed files, the read user data box including at least one third box including information that can be used to identify a track box indicating a track with the user data defined in the track; and reading user data regarding the media data using the read third box and decoding and processing the read user data and the demultiplexed media data.

Here, the third box may further include information regarding a start position of each user data in the track indicated by the track box.

In addition, the third box may further include information that can be used to identify a user who has added user data in the first box.

Moreover, the third box may further include information regarding a version of user data in the first box.

Another embodiment of the invention provides a method for receiving and processing a broadcast signal including files defined according to a specific file format, the method including receiving and storing the broadcast signal; demultiplexing files in the stored broadcast signal, each of the demultiplexed files including a first box including at least one track including media data and user data regarding the media data and a second box including a track box identifying each of the at least one track and including a user data box that defines data and an informative format of users regarding the user data; reading a user data box in each of the demultiplexed files, the read user data box including at least one third box including information regarding a start position of the user data in the corresponding track; and reading user data regarding the media data using the read third box and decoding and processing the read user data and the demultiplexed media data.

Here, the third box may further include information that can be used to identify a user who has added user data in the first box.

In addition, the third box may further include information regarding a version of user data in the first box.

Another embodiment of the invention provides an apparatus for receiving and processing a broadcast signal including files defined according to a specific file format, the apparatus including a storage unit for receiving and demultiplexing the broadcast signal and storing files of the broadcast signal; a first decoder for reading and decoding boxes included in each of the stored files, the decoded boxes including a first box including at least one track with both media data and user data regarding the media data defined in the at least one track and a second box including a track box indicating each of the at least one track and a user data box that defines data and an informative format of a user regarding the user data, the user data box including at least one third box including information that can be used to identify a track box indicating a track with the user data defined in the track and information regarding a start position of user data in a track indicated by the track box; a controller for performing a control operation to decode user data and media data in the stored first box using the decoded third box or to construct a UI; and a second decoder for decoding the user data and the media data or constructing a UI according to control of the controller.

Here, the apparatus may further include an output unit for outputting the user data and media data decoded by the second decoder or outputting the constructed UI.

In addition, the controller may control the second decoder to construct a UI associated with the decoded user data and media data.

Another embodiment of the invention provides an apparatus for receiving and processing a broadcast signal including files defined according to a specific file format, the apparatus including a storage unit for receiving and demultiplexing the broadcast signal and storing files of the broadcast signal; a first decoder for reading and decoding boxes included in each of the stored files, the decoded boxes including a first box including at least one track including media data and user data regarding the media data and a second box including a track box identifying each of the at least one track and including a user data box that defines data and an informative format of users regarding the user data, the user data box including at least one third box including information regarding a start position of the user data in the corresponding track; a controller for performing a control operation to decode the stored user data and media data or to construct a UI using information in the decoded third box; and a second decoder for decoding the stored user data and media data or constructing a UI according to control of the controller.

Here, the apparatus may further include an output unit for outputting the user data and media data decoded by the second decoder.

In addition, the controller may control the second decoder to construct a UI in association with the decoded user data and media data.

### Advantageous Effects

The method for constructing a file format including user data and the apparatus and method for processing a broadcast signal including a file having the file format have a variety of advantages.

First, multiple users can individually store their own unique data in previously created files.

Second, it is possible to intuitively determine which track is specified by each user data.

Thus, according to the invention, it is possible to store a plurality of user data and also to specify user data suitable for a plurality of tracks even when the user data is provided in a moov container. In the case where user data is provided in a track container, even when a corresponding track contains only one media data item, multiple users can specify user data relevant to them. In addition, even when media data is added and connected to the media data in the corresponding track, it is possible to additionally specify user data suitable for the media data.

### BRIEF DESCRIPTION OF THE DRAWINGS

FIG. 1 illustrates the structure of an ISO-based media file format in association with the invention;

FIG. 2 illustrates an embodiment of user data constructed according to the invention;

FIG. 3 illustrates an embodiment of a syntax structure constructed in association with the user data constructed in FIG. 2;

FIG. 4 illustrates another embodiment of user data constructed according to the invention;

FIG. 5 illustrates an embodiment of a syntax structure provided to explain the embodiment of FIG. 4;

FIG. 6 illustrates an embodiment of a file format constructed according to the invention;

FIG. 7 illustrates another embodiment of a file format constructed according to the invention;

FIG. 8 illustrates another embodiment of a file format constructed according to the invention;

FIG. 9 illustrates another embodiment of a file format constructed according to the invention;

FIG. 10 illustrates a block diagram illustrating an embodiment of an apparatus for processing a file format constructed according to the invention; and

FIG. 11 is a flow chart illustrating an embodiment of a procedure for processing a file format constructed according to the invention.

### REFERENCE NUMERALS OF THE ESSENTIAL PARTS IN THE DRAWINGS

1001; tuner 1002; demodulator

1003; demultiplexer 1004; storage medium

1005: 1st decoder 1006; 2nd decoder

1007; processor 1008; output unit

1009; controller

### BEST MODE FOR CARRYING OUT THE INVENTION

The above and other objects, features, and advantages of the invention will be clearly understood from the following detailed description taken in conjunction with the accompanying drawings. Although most terms of elements in the present invention have been selected from general ones widely used in the art taking into consideration their functions in the invention, some terms have been arbitrarily selected by the applicant and their meanings are explained in detail in the following description as needed. Thus, the definitions of the terms used in the invention should be determined based on the whole content of this specification together with the intended meanings of the terms rather than their simple names or meanings.

A method and apparatus for a plurality of users storing their own unique data in files according to the invention will now be described with reference to the accompanying drawings.

In the following description provided for more clear understanding of the spirit of the invention, the digital broadcast signal is exemplified by a signal for digital multimedia broadcasting and the file format is exemplified by an ISO-based file format for ease of explanation.

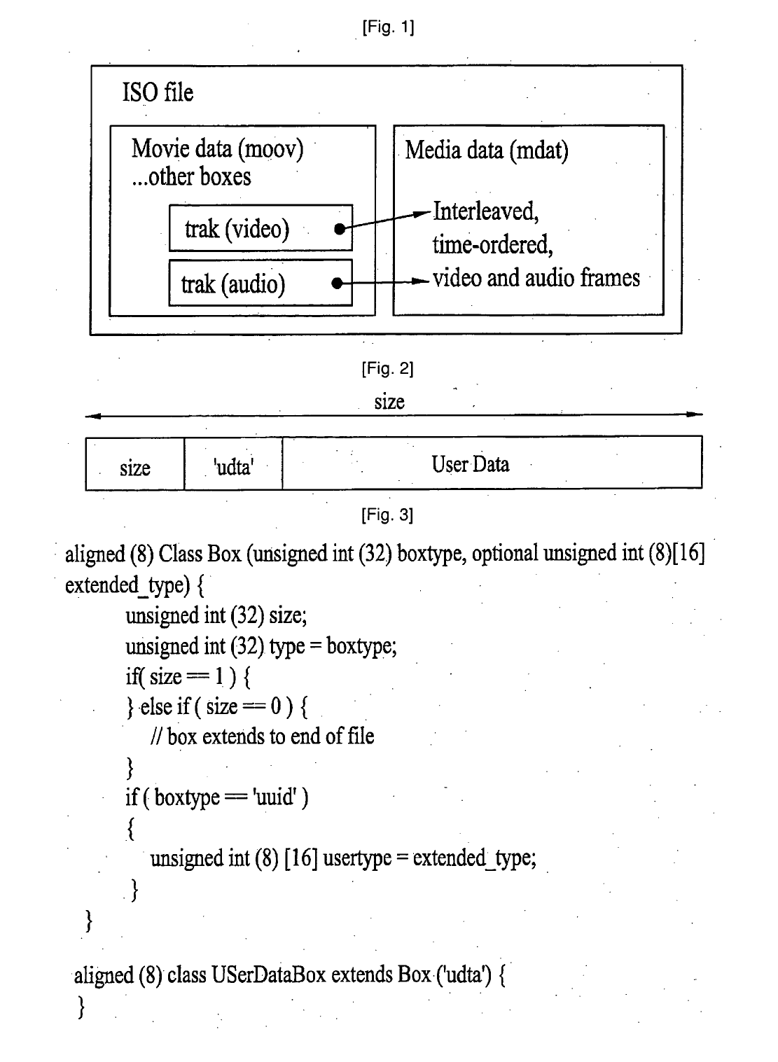

FIG. 1 illustrates the structure of an ISO-based media file format in association with the invention.

The ISO-based media file format includes a collection of object-oriented blocks, which are referred to as “boxes,” as shown in FIG. 1. The file format includes not only audio/video (A/V) but also timing, structure, and media information.

The following is a description of the boxes. In the following description, box names will be given in bold for ease of explanation. Boxes can be basically classified into container boxes and general boxes. Here, although the container box may be a grouping box that includes other boxes therein, the container box may contain the total size and name of the grouped boxes while the general boxes contain data provided for actual use.

FIG. 1 shows an example ISO file format which includes a moov box, an mdat box, and a trak box.

The moov box can be described as an example container box which includes at least one trak box that is used to present a scene. The trak box may include a description of single media data (i.e., one media data item).

The media data in the trak box includes information compressed using a variety of codecs such as audio and video information, information regarding audio-only broadcasts, information regarding a transport stream containing muxed audio and video data, and information regarding content of a data broadcast.

The following is a more detailed description of each of the boxes. As a movie box, the moov box is a container box that may include all meta data boxes associated with an actual movie. Accordingly, the moov box does not contain any information of its own but serves to group other boxes therein.

As a container box, the moov box may contain at least one trak box as described above.

As a track box, the trak box is a container box that may store information regarding one track for presentation. For example, the trak (video) box represents a track containing video data and the trak (audio) box represents a track containing audio data. That is, when one track of audio data has been stored, all information regarding the audio data can be stored in boxes and the trak box serves to group these boxes.

The mdat box is a media data box that stores an actual stream. Since the stream stored in the mdat box contains no information, a position and information regarding the current stream may be obtained from the mdat box.

In the example of FIG. 1, the moov box includes two trak boxes, i.e., a trak (video) box and a trak (audio) box, and the mdat box includes interleaved audio and video frames or time-ordered audio and video frames which are actual information of a broadcast indicated by the trak box.

Accordingly, via streaming or using a storage device, the transmitting end can transmit each file containing data using the ISO-based file format structure as described above through various paths. The receiving end can receive or copy and store the file from the streaming or storage device and then reproduce the stored file.

Although the file format as shown in FIG. 1 is defined taking into consideration distribution and streaming from the viewpoint of service providers where content creators hold existing content, a “user data” box can be provided to achieve flexibility to cope with other situations.

For example, the utility of such user data will be increased when various users encounter a situation where they can edit content and add a new value to content regardless of copyright as general passive users who only consume content are increasingly changed to active creators with the recent spread of concepts such as the rapidly growing User Created Content (UCC) movement.

Accordingly, the invention aims to provide a method for more broadly utilizing user data, thereby adding a high value to content production activities of various content creators.

“User data” in the invention is a general term used to describe informative formats and data of users, i.e., information which can be optionally defined by the user. The user data may include various information including data and informative formats desired by creators such as meta data, Intellectual Property Management and Protection (IPMP), Audio/Video (AV), text, database (DB), etc.

Reference will now be made to user data defined according to the ISO-based file format in association with the invention.

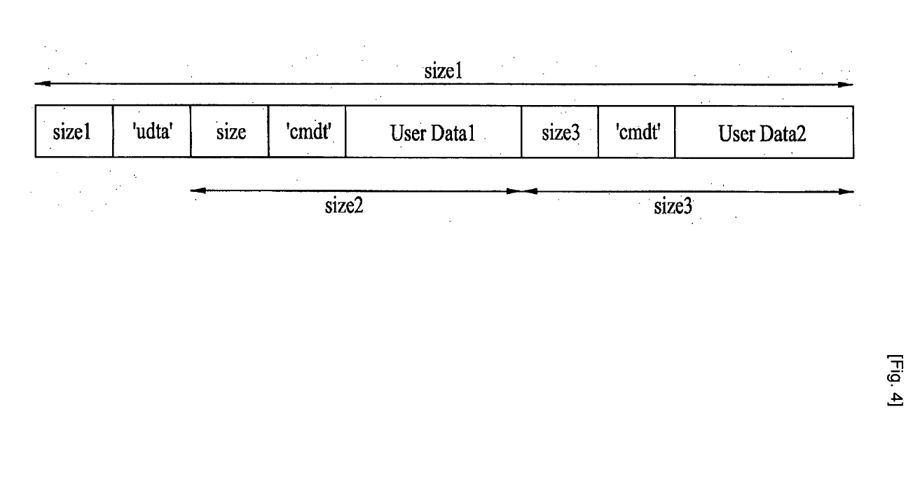

The following is a more detailed description of user data in association with the invention. FIG. 2 illustrates an embodiment of user data constructed according to the invention and FIG. 3 illustrates an embodiment of a syntax structure constructed in association with the user data constructed in FIG. 2.

In association with the invention, the user data may be included in a box type “udta”. Although the “udta” box is a container box, it can be contained in another container box, for example a “moov” box or a “trak” box. Although the “udta” box is not a mandatory box that must be included in the file format, it can be used as a mandatory box taking into consideration the variety of recent broadcast environments as described above.

The “udta” box may include at least one user data item.

The embodiment of FIG. 2 is a basic structure in which single user data (i.e., one user data item) is included in the “udta” box. The structure mainly includes a section indicating size, a section indicating the type of a box containing user data, and a section containing actual user data. Specifically, the “size” section indicates the total size of a box type containing user data, the “udta” section indicates that the box type containing the user data is a “udta” box, and the “User Data” section indicates a section containing actual user data.

FIG. 3 illustrates a class box which is an embodiment of a syntax structure provided to explain the basic user data structure of FIG. 2.

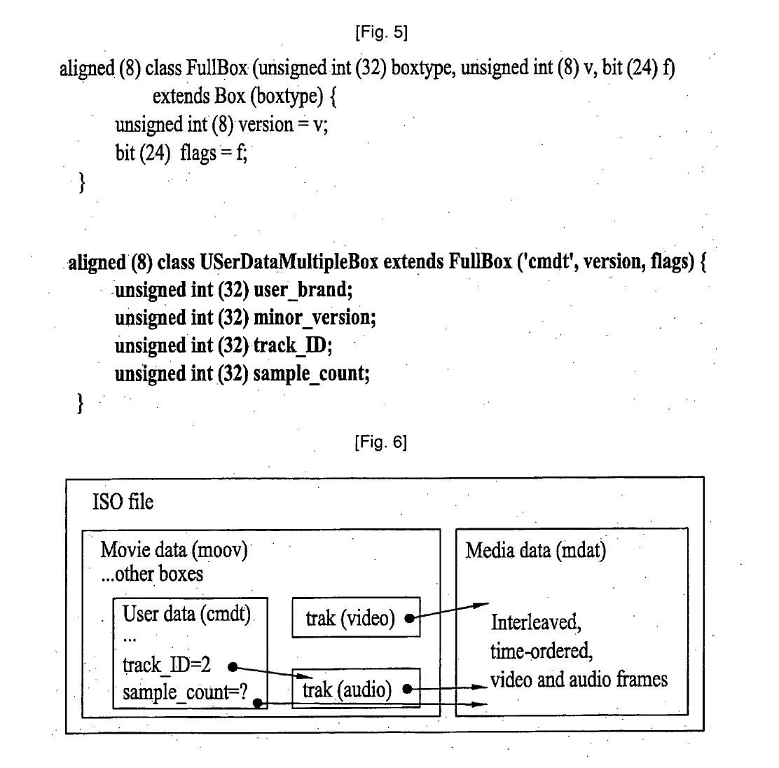

FIG. 4 illustrates another embodiment of user data constructed according to the invention and FIG. 5 illustrates an embodiment of a syntax structure provided to explain the embodiment of FIG. 4.

The embodiment of FIG. 4 is constructed taking into consideration the fact that a plurality of user data can be included in the “udta” box, unlike the embodiment of FIG. 2. The following description will be given with reference to an example where the “udta” box includes two user data items for ease of explanation.

The basic structure of the embodiment of FIG. 4 is similar to that of FIG. 2. That is, “size1” indicates the total size of a “udta” box that is a container box containing at least one user data item, “size2” indicates the size of a “cmdt” box containing the first of the at least one user data items, and “size3” indicates the size of a “cmdt” box containing the second user data item.

Although the file includes two user data items in the example of FIG. 4, the file may include additional user data items. In this case, the file format can be defined so as to further include the respective sizes, box types, and actual user data of the additional user data items as described above.

While the “cmdt” box is not included in the example of FIG. 2 which includes one user data item, “cmdt” boxes are included in the example of FIG. 4 in order to allow the “udta” container box to include a plurality of user data items. The “cmdt” boxes are used to distinguish between sections containing the user data items and each of the “cmdt” boxes contains actual user data.

FIG. 5 is an embodiment of a syntax structure provided for explaining the user data constructed in FIG. 4. This embodiment is constructed of a plurality of boxes including “class FullBox” and “class USerDataMultipleBox extends FullBox” in addition to “Class Box” of FIG. 3.

In the syntax of FIG. 5, “user_brand” represents an identifier (ID) of a user who has added user data, “minor_version” represents the version of user data, “track_ID” represents a track ID which specifies a track for containing user data when the container box is a moov box, and “sampe_count” represents a start position of a sample of user data in an mdat box, i.e., in media data.

However, if the container box is not a moov box, the syntax may not include the track_ID since the track ID is already included in a track to be specified and as such separate definition of the track ID is unnecessary.

Reference will now be made to embodiments of a file format constructed using the structure of FIG. 4.

FIG. 6 illustrates an embodiment of a file format of user data constructed according to the invention in the case where a plurality of tracks is provided.

As shown in FIG. 6, an ISO file format includes a moov box and an mdat box. The moov box includes a cmdt box containing user data, described above in the embodiments of FIGS. 3 and 4 according to the invention, a trak (video) box, and a trak (audio) box.

Here, the trak (video) box indicates that the mdat box contains video data and also indicates the position of the video data. The trak (audio) box indicates that the mdat box contains audio data and also indicates the position of the audio data. The cmdt box according to the invention may include at least one of information identifying the track and information indicating a detailed position of the user data in the mdat box.

In FIG. 6, the cmdt box containing user data can specify an audio track, for example when the track ID is 2 (track_ID=2), and can specify a section, which contains actual user data, in the audio track, for example using “sample_count=xx”. That is, the embodiment of FIG. 6 indicates that the ISO file includes user data regarding audio data according to the invention.

In FIG. 6, one of a plurality of trak boxes in the moov box is specified to indicate that the ISO file includes user data of the corresponding track.

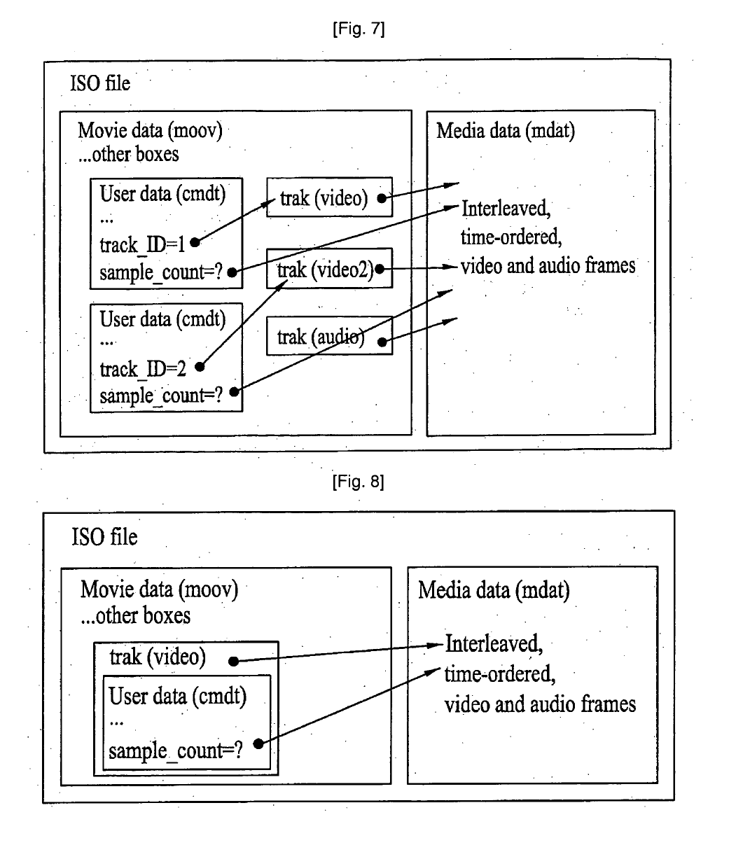

FIG. 7 illustrates another embodiment of a file format of user data constructed according to the invention where the user data is constructed such that each of a plurality of tracks can be specified.

The basic structure of the embodiment of FIG. 7 is similar to that of FIG. 6. The following description of the embodiment of FIG. 7 will be given focusing on different portions of the embodiment from those of FIG. 6 while the same portions of the embodiment of FIG. 7 as those of FIG. 6 will be omitted.

Unlike the embodiment of FIG. 6, the embodiment of FIG. 7 includes a plurality of cmdt boxes containing user data. Specifically, according to the invention, an ISO file format is constructed to indicate that the file includes three tracks (i.e., video (track_ID=1), video 2 (track_ID=2), and audio (track_ID=3)) and includes user data of the video track and user data of the video 2 track.

Accordingly, the cmdt box indicating user data of video data includes “track_ID=1” and includes “sample_count” indicating an actual position of user data in the video data specified by the trak (video) box.

The cmdt box indicating user data of video data 2 includes “track_ID=2” and includes “sample_count” indicating an actual position of user data 2 in the video data specified by the trak (video2) box.

In the embodiment of FIG. 7, a cmdt box including user data is included in a moov container box according to the invention, so that, when the moov box includes a plurality of trak boxes, each of the plurality of trak boxes can be specified to indicate that the file includes respective user data of corresponding tracks.

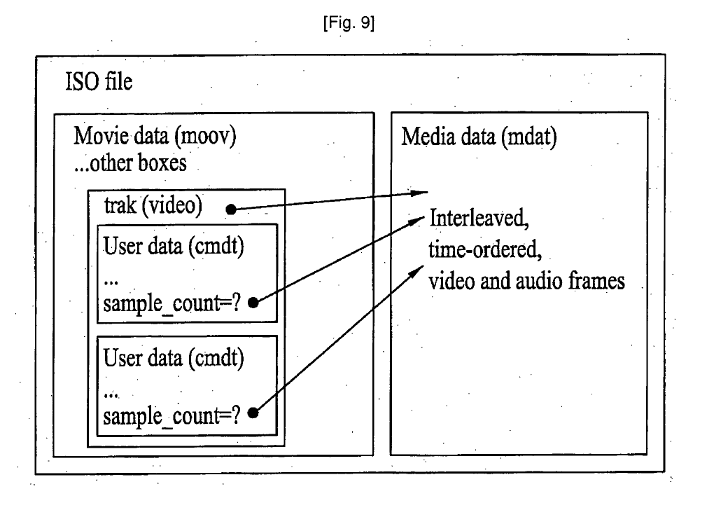

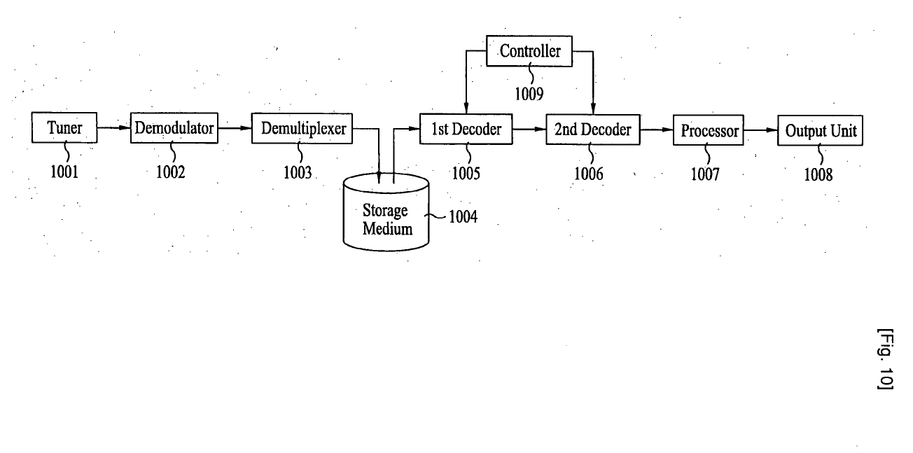

FIG. 8 illustrates another embodiment of a file format constructed according to the invention in the case where one track includes one cmdt box indicating user data. FIG. 9 illustrates another embodiment of a file format constructed according to the invention in the case where one track includes a plurality of cmdt boxes indicating user data.

In the embodiments of FIGS. 8 and 9, a trak box includes a cmdt box(es) including user data, unlike those of FIGS. 6 and 7.

One trak box includes one cmdt box in the embodiment of FIG. 8 and one trak box includes a plurality of cmdt boxes in the embodiment of FIG. 9. In these examples, since the trak box includes the cmdt box(es) including user data, it is possible to identify a track(es) corresponding to the user data and thus it is unnecessary to separately define track_ID information, unlike in the examples of FIGS. 6 and 7. However, a sample_count value indicating a section containing user data in the corresponding track should be defined in each cmdt box.

FIG. 8 illustrates another structure of the embodiment of FIG. 6. While user data is defined using information of the sample position (sample_count) and the (audio) track ID (track_ID) included in the moov box in the embodiment of FIG. 6, the cmdt box is included in the trak box and user data is defined using information of the sample position (sample_count) without separately defining information of (video) track ID (track_ID) in the embodiment of FIG. 8.

Thus, FIGS. 6 and 8 illustrate embodiments of a file format indicating that the file includes single user data regarding media data included in a single track.

FIG. 7 shows an embodiment of a file format indicating that the file includes two media data items, each containing user data, among media data items included in tracks, i.e., indicating that the file includes two tracks identical to that of FIG. 6.

The embodiment of FIG. 9 illustrates another embodiment of a file format constructed according to the invention in the case where two user data items are included in a video track containing video data unlike the embodiments of FIGS. 6 to 8. For example, let us assume that the video track includes a movie (video data). For example, one user may create the first and second episodes of a movie series and include them in a video track and another user may create the third episode and include it in the video track.

According to the invention, for example when user data is provided in a moov box, it is possible to specify user data for each of a plurality of tracks and also to intuitively determine which track is specified by the user data. In addition, when user data is included in a trak box, user data of added or deleted content can be added to or deleted from the track.

According to the invention, the basic file format of user data includes a data box. When the basic file format includes a data box according to the invention, it can store a plurality of user data.

FIG. 10 illustrates a block diagram illustrating an embodiment of an apparatus for processing a file format constructed according to the invention.

A broadcast receiver of FIG. 10 may include a tuner unit 1001, a demodulator 1002, a demultiplexer 1003, a storage medium 1004, a first decoder 1005, a second decoder 1006, a processor 1007, a display unit 1008, and a controller 1009.

The tuner unit 1001 tunes in and receives a broadcast signal transmitted through a channel.

The demodulator 1002 demodulates the received broadcast signal according to a scheme corresponding to a modulation scheme.

The demultiplexer 1003 demultiplexes the demodulated broadcast signal.

The storage medium 1004 contains file formats constructed for broadcasting as described above and outputs corresponding files. The files include files having various file format structures such as audio-only files, video-only files, and data-only files and each file can include at least one user data item according to the invention as described above.

The first decoder 1005 is a file decoder for decoding files having the above file format structures. The first decoder 1005 reads received files having file format structures and decodes and extracts only media-data-related part of the files.

The second decoder 1006 decodes files according to their characteristics to create data.

The controller 1009 controls the first and second decoders 1005 and 1006 to decode and output media data and related user data together. That is, the controller 1009 can control the first decoder 1005 to decode a cmdt box defined according to the invention in association with user data regarding media data stored in the storage medium 1004 and control the second decoder 1006 to decode the user data together with the media data using information in the decoded cmdt box.

The processor 1007 receives the data generated by the second decoder 1006 and processes and outputs the received data according to characteristics of a corresponding file. In the case where the received data includes a portion indicating that user data is included therein, the processor 1007 processes the user data so that the user data can be decoded together with corresponding media data while the user data is output separately from the media data, thereby allowing the user to select the data.

The display unit 1008 displays each processed data item according to characteristics of the corresponding file. In the case where user data is included in the corresponding file and is separately processed and output as described above, the user data may be separately provided to the user, allowing the user to select the user data, when a user interface (UI) is constructed.

In association with the invention, when the file having the above file format structure is a file for an audio-only broadcast, the second decoder 1006 may be an audio decoder, particularly an MPEG-1 audio decoder, which decodes an audio-only broadcast file compressed in an MPEG-1 layer 2 (MUSICAM) format, extracted at the first decoder 1005, thereby generating PCM data. The generated PCM data is processed at the audio processor 1007 and the processed PCM data is then output through a speaker of a display unit.

In the case where the file is a file for a transport stream, the second decoder 1006 functions as an audio and video decoder after audio and video data multiplexed in the transport stream is demultiplexed through the demultiplexer (not shown).

For example, an MPEG-4 audio decoder decodes the extracted audio data according to the MPEG-4 Bit Sliced Arithmetic Coding (BSAC) standard and an audio processor receives and processes the decoded audio data and outputs PCM data through the speaker.

In addition, an MPEG-4 video decoder decodes the extracted video data according to the MPEG-4 Advance Video Coding (AVC) standard and a video processor receives and processes the decoded video data and outputs PCM data through a screen of the display unit.

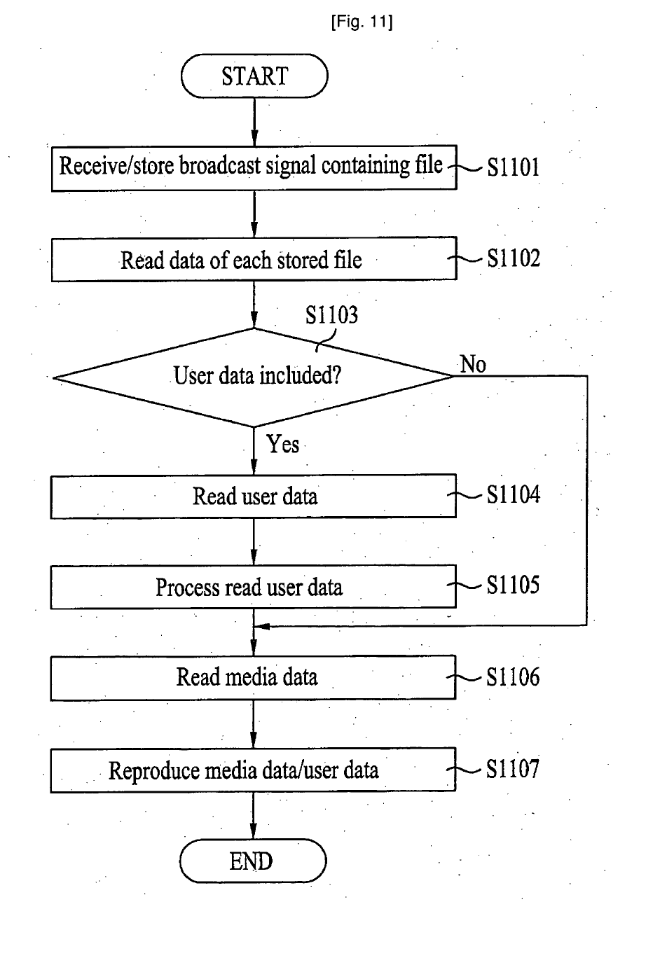

FIG. 11 is a flow chart illustrating an embodiment of a procedure for processing a file format constructed according to the invention.

The flow chart of FIG. 11 is provided to explain the procedure of the embodiment of FIG. 10.

A broadcast signal including each file having a file format structure constructed according to the invention is received and stored in the storage medium 1001 (S1101).

The stored data of each file is read (S1102) and whether or not the read data includes user data is determined (S1103).

If the read data includes user data, the user data is read (S1104) and the read user data is then processed (S1105).

After the user data is processed, media data is read (S1106) and the processed user data is used according to characteristics of the user data or the processed user data is reproduced together with or separately from the media data that is processed after being read (S1007).

For example, the processed user data can be used to reproduce media data when the user data is of the same type as database that is required to reproduce media data.

However, when the user data is information such as a caption that should be displayed simultaneously with media data or when the user data is an episode in a series of the media data, the user data can be reproduced simultaneously with or subsequent to the media data according to selection of the user after the user data is provided to the user through a UI.

### INDUSTRIAL APPLICABILITY

According to the apparatus and method for constructing a file format including user data and processing a broadcast signal including files having the file format according to the invention, multiple users can individually store their unique user data in previously created files. It is also possible to intuitively determine which track is specified by each user data. In addition, a receiver can process and provide files having the file format to users.

1. A method for constructing a file format, wherein the file format includes a first box (mdta) including at least one track with both media data and user data regarding the media data defined in the at least one track and a second box (moov) including a track box (trak) indicating each of the at least one track and a user data box (udta) that defines data and an informative format of a user regarding the user data, wherein the user data box (udta) includes at least one third box (cmdt) including information that can be used to identify a track box indicating a track with the user data defined in the track.

2. The method according to claim 1, wherein the third box further includes information regarding a start position of each user data in the track indicated by the track box.

3. The method according to claim 2, wherein the third box further includes information that can be used to identify a user who has added user data in the first box.

4. The method according to claim 2, wherein the third box further includes information regarding a version of user data in the first box.

5. A method for constructing a file format, wherein the file format includes a first box (mdta) including at least one track with both media data and user data regarding the media data defined in the at least one track and a second box (moov) including a track box (trak) indicating each of the at least one track and including a user data box (udta) that defines data and an informative format of a user regarding the user data, wherein the user data box (udta) includes at least one third box (cmdt) including information regarding a start position of the user data in the corresponding track.

6. The method according to claim 5, wherein the third box further includes information that can be used to identify a user who has added user data in the first box.

7. The method according to claim 5, wherein the third box further includes information regarding a version of user data in the first box.

8. A method for receiving and processing a broadcast signal including files defined according to a specific file format, the method comprising: receiving and storing the broadcast signal; demultiplexing files in the stored broadcast signal, each of the demultiplexed files including a first box including at least one track with both media data and user data regarding the media data defined in the at least one track and a second box including a track box indicating each of the at least one track and a user data box that defines data and an informative format of a user regarding the user data; reading a user data box in each of the demultiplexed files, the read user data box including at least one third box including information that can be used to identify a track box indicating a track with the user data defined in the track; and reading user data regarding the media data using the read third box and decoding and processing the read user data and the demultiplexed media data.

9. The method according to claim 8, wherein the third box further includes information regarding a start position of each user data in the track indicated by the track box.

10. The method according to claim 9, wherein the third box further includes information that can be used to identify a user who has added user data in the first box.

11. The method according to claim 9, wherein the third box further includes information regarding a version of user data in the first box.

12. A method for receiving and processing a broadcast signal including files defined according to a specific file format, the method comprising: receiving and storing the broadcast signal; demultiplexing files in the stored broadcast signal, each of the demultiplexed files including a first box including at least one track including media data and user data regarding the media data and a second box including a track box identifying each of the at least one track and including a user data box (udta) that defines data and an informative format of users regarding the user data; reading a user data box in each of the demultiplexed files, the read user data box including at least one third box (cmdt) including information regarding a start position of the user data in the corresponding track; and reading user data regarding the media data using the read third box and decoding and processing the read user data and the demultiplexed media data.

13. The method according to claim 12, wherein the third box further includes information that can be used to identify a user who has added user data in the first box.

14. The method according to claim 12, wherein the third box further includes information regarding a version of user data in the first box.

15. An apparatus for receiving and processing a broadcast signal including files defined according to a specific file format, the apparatus comprising: a storage unit for receiving and demultiplexing the broadcast signal and storing files of the broadcast signal; a first decoder for reading and decoding boxes included in each of the stored files, the decoded boxes including a first box including at least one track with both media data and user data regarding the media data defined in the at least one track and a second box including a track box indicating each of the at least one track and a user data box that defines data and an informative format of a user regarding the user data, the user data box including at least one third box including information that can be used to identify a track box indicating a track with the user data defined in the track and information regarding a start position of user data in a track indicated by the track box; a controller for performing a control operation to decode user data and media data in the stored first box using the decoded third box or to construct a UI; and a second decoder for decoding the user data and the media data or constructing a UI according to control of the controller.

16. The apparatus according to claim 15, further comprising: an output unit for outputting the user data and media data decoded by the second decoder or outputting the constructed UI.

17. The apparatus according to claim 16, wherein the controller controls the second decoder to construct a UI in association with the decoded user data and media data.

18. An apparatus for receiving and processing a broadcast signal including files defined according to a specific file format, the apparatus comprising: a storage unit for receiving and demultiplexing the broadcast signal and storing files of the broadcast signal; a first decoder for reading and decoding boxes included in each of the stored files, the decoded boxes including a first box including at least one track including media data and user data regarding the media data and a second box including a track box identifying each of the at least one track and including a user data box (udta) that defines data and an informative format of users regarding the user data, the user data box including at least one third box (cmdt) including information regarding a start position of the user data in the corresponding track; a controller for performing a control operation to read and decode the stored user data and media data using information in the decoded third box; and a second decoder for reading and decoding the stored user data and media data according to control of the controller.

19. The apparatus according to claim 18, further comprising: an output unit for outputting the user data and media data decoded by the second decoder.

20. The apparatus according to claim 19, wherein the controller controls the second decoder to construct a UI in association with the decoded user data and media data.

21. The method according to claim 3, wherein the third box further includes information regarding a version of user data in the first box.

22. The method according to claim 6, wherein the third box further includes information regarding a version of user data in the first box.

23. The method according to claim 10, wherein the third box further includes information regarding a version of user data in the first box.

24. The method according to claim 13, wherein the third box further includes information regarding a version of user data in the first box.
